(19) United States
(12) Patent Application Publication
(10) Pub. No.: US 2025/0316066 A1
(43) Pub. Date: Oct. 9, 2025

(54) SENSOR FUSION APPARATUS AND METHOD FOR TRANSPORTATION APPARATUS

(71) Applicant: HYUNDAI MOBIS CO., LTD., Seoul (KR)

(72) Inventors: Dong Yun SON, Yongin-si (KR); Ji Su KIM, Yongin-si (KR)

(73) Assignee: HYUNDAI MOBIS CO., LTD., Seoul (KR)

(21) Appl. No.: 18/954,930

(22) Filed: Nov. 21, 2024

(30) Foreign Application Priority Data
Apr. 4, 2024 (KR) 10-2024-0045985

(51) Int. Cl. G06V 10/80; G06V 10/762; G06V 20/56

(52) U.S. Cl. CPC G06V 10/80; G06V 10/762; G06V 20/56

(57) ABSTRACT

A sensor fusion apparatus for a transportation apparatus including two or more sensors, each of the two or more sensors having different sensing characteristics, each of the two or more sensors sensing an object, respectively, one or more processors configured to execute instructions, and a memory storing the instructions, an execution of the instructions configures the one or more processors to perform first preprocessing and second preprocessing, the first preprocessing and second preprocessing including grid mapping for each object sensed by two or more sensors, respectively and perform sensor fusion through clustering using an integrated grid map for each grid-mapped object.

### CROSS-REFERENCE TO RELATED APPLICATION

This application claims priority from and the benefit under 35 USC § 119(a) of Korean Patent Application No. 10-2024-0045985, filed on Apr. 4, 2024, the entire disclosure of which is incorporated herein by reference for all purposes.

### BACKGROUND

### 1. Field

Exemplary embodiments of the present disclosure relate to sensor fusion apparatus and method for a transportation apparatus, which may enable fusion of an ultrasonic sensor and a camera sensor mounted on the transportation apparatus by using a grid map.

### 2. Description of the Related Art

In general, a parking assistance system (Remote Smart Parking Assis, RSPA) of a transportation apparatus (e.g., a vehicle and the like) for transporting people or cargo uses an ultrasonic sensor to enable a vehicle to identify a parking space on its own and assists in parking by controlling steering, braking, speed, forward/reverse gear shifting, and the like.

In this way, the conventional parking assistance system (RSPA) identifies an object, such as a nearby vehicle, based on the ultrasonic sensor, and then executes parking while steering to avoid the identified object.

However, because the ultrasonic sensor alone does not provide high accuracy in obstacle identification, a method that detects an obstacle by fusing sensing values from a camera sensor has also been used to improve identification accuracy.

In this case, the conventional sensor fusion method uses the Probabilistic Data Association Filter (PDAF). However, the complexity of the mathematical equations involved in the PDAF imposes high computational load on a processor (controller), which may cause a reset due to computational overload. In addition, the excessive computational load makes it difficult to add a new feature and enhance performance.

Therefore, there is a need for a method that may reduce computational load, compared to the conventional method, when fusing sensing data from the ultrasonic sensor and image data from the camera sensor.

### SUMMARY

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

In a general aspect, here is provided a sensor fusion apparatus for a transportation apparatus including two or more sensors, each of the two or more sensors having different sensing characteristics, each of the two or more sensors sensing an object, respectively, one or more processors configured to execute instructions, and a memory storing the instructions, an execution of the instructions configures the one or more processors to perform first preprocessing and second preprocessing, the first preprocessing and second preprocessing including grid mapping for each object sensed by two or more sensors, respectively and perform sensor fusion through clustering using an integrated grid map for each grid-mapped object.

The first preprocessing may include performing Time of Flight (TOF) preprocessing and the grid mapping for a first object detected through an ultrasonic sensor of the two or more sensors and the second preprocessing may include performing object detection (OD) preprocessing and the grid mapping for a second object detected through a camera sensor of the two or more sensors.

The performing the sensor fusion may include clustering, through an intersection of an object calculated through the preprocessing and performing object box gating of an object calculated through the second preprocessing, by using the integrated grid map.

The performing the sensor fusion may include searching for occupancy scores of grids within an object box and performing clustering with an average value of grids having highest scores within the object box to calculate a final fusion representative point.

The performing the sensor fusion may include, responsive to determining there is no grid mapping information from a first sensor of the one or more sensors accumulated within the object box, assessing the object box to be a ghost object box, and deleting ghost object boxes.

The performing the sensor fusion may include acquiring a first Time of Flight (TOF) value of a direct wave and a second TOF value of an indirect wave detected through a first sensor of the two or more sensors through the first preprocessing and responsive to a direct wave value being among the first TOF values, performing grid mapping aligned with a field of view (FOV) of the first sensor.

The performing the sensor fusion may include, responsive to a TOF value of an indirect wave being among the first TOF values, performing grid mapping only on an intersection area of direct and indirect waves.

The performing the sensor fusion may include acquiring object detection information from image data detected through a second sensor of the two or more sensors through the second preprocessing and responsive to objects being confirmed to be the same through a comparison of previous and current values of the object detection information correcting a coordinate value and an area value based on a specified parameter by using a specified filter and performing grid mapping in a form of a box.

The performing the sensor fusion may include integrating grid mapping information on an intersection area of direct and indirect waves among TOF values acquired through a first sensor of the two or more sensors, grid mapping information in a form of an object box on object detection information detected through a second sensor of the two or more sensors, and mapping all the information on a single integrated grid map.

In a general aspect, here is provided a method including performing, by a processor, preprocessing and grid mapping corresponding to a first sensor and a second sensor, respectively and performing, by the processor, sensor fusion through clustering using an integrated grid map for each preprocessed and grid-mapped object information.

### BRIEF DESCRIPTION OF THE DRAWINGS

FIG. 1 is an exemplary view showing a schematic configuration of a sensor fusion apparatus for a transportation apparatus according to an embodiment of the present disclosure.

FIG. 2 is an exemplary view illustrating a sensor fusion method for a transportation apparatus according to an embodiment of the present disclosure.

FIG. 3 is an exemplary view illustrating operations of preprocessing and grid mapping for an object detected through a first sensor and a second sensor in FIG. 2.

FIGS. 4A, 4B, 4C, and 4D provide an exemplary view illustrating operations of preprocessing and multi-grid mapping for an object detected through the first sensor and the second sensor in FIG. 2.

FIGS. 5A, 5B, and 5C provide an exemplary view illustrating grid mapping for direct and indirect waves detected through the first sensor (ultrasonic sensor) in FIG. 2.

FIG. 6 is an exemplary view illustrating object detection (OD) preprocessing and grid mapping for an object detected through the second sensor (camera sensor) in FIG. 2.

FIGS. 7A, 7B, 7C, and 7D provide an exemplary view illustrating a method for calculating a sensor fusion coordinate of an object on a grid map during the multi-grid mapping operation in FIG. 4.

FIGS. 8, 9, 10A, 10B, 10C, and 10D are exemplary views illustrating an improved effect of sensor fusion according to an embodiment of the present disclosure compared to conventional sensor fusion.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

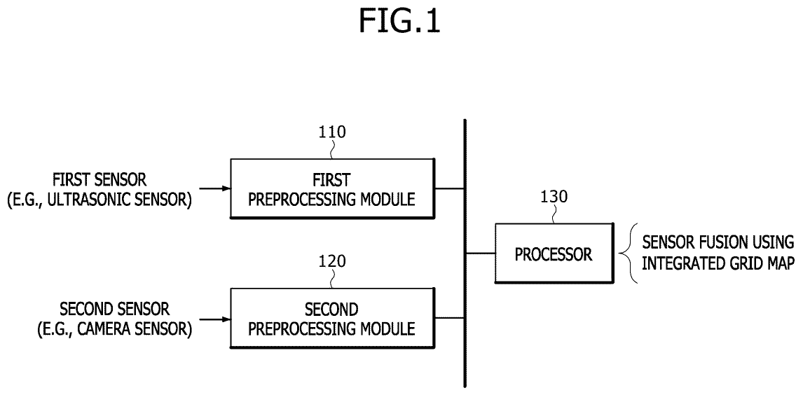

FIG. 1 is an exemplary view showing a schematic configuration of a sensor fusion apparatus for a transportation apparatus according to an embodiment of the present disclosure.

As illustrated in FIG. 1, the sensor fusion apparatus for a transportation apparatus according to the present embodiment may include two or more sensors (i.e., a first sensor and a second sensor) having different sensing characteristics, a first preprocessing module 110 and a second preprocessing module 120 performing preprocessing, corresponding to the at least two sensors (the first sensor and the second sensor), respectively, and a processor 130 performing sensor fusion by using an integrated grid map.

A grid map refers to a map in which Time of Flight (i.e., TOF, distance value) information of an object is accumulated in each grid (cell) through an ultrasonic sensor.

Among the at least two sensors, the first sensor includes an ultrasonic sensor detecting an object by using ultrasonic waves, and the second sensor includes a camera sensor.

The first preprocessing module 110 preprocesses signals (sensing data) of the object (e.g., a person, a car, an obstacle, and the like) detected by the first sensor (e.g., an ultrasonic sensor).

The first preprocessing module 110 performs Time of Flight (i.e., TOF, distance value) preprocessing and grid mapping for the object.

The second preprocessing module 120 preprocesses signals (image data) of an object detected through the second sensor (e.g., a camera sensor).

The second preprocessing module 120 performs object detection (OD) preprocessing and grid mapping for the object.

The processor 130 uses the integrated grid map to perform sensor fusion on the signals (sensing data and image data) preprocessed through the first preprocessing module 110 and the second preprocessing module 120, respectively.

The processor 130 uses the integrated grid map to perform clustering through an intersection of target information (i.e., an object) calculated through the first preprocessing module 110 and object box gating (i.e., OD_Box_Gating, inserting object information in the form of a box on the grid map) of target information (i.e., object information) calculated through the second preprocessing module 120.

The processor 130 clusters the largest values among the grid mapping information from the first sensor (i.e., grid mapping information on an intersection area of direct and indirect waves acquired through the first sensor (e.g., an ultrasonic sensor)) accumulated within an object box (OD_Box) to calculate a final coordinate (i.e., a final object coordinate).

If there is no grid mapping information from the first sensor (i.e., grid mapping information on an intersection area of direct and indirect waves acquired through the first sensor (e.g., an ultrasonic sensor)) accumulated within an object box (OD_Box), the processor 130 determines the object box to be a ghost and deletes the same.

For reference, when the first sensor (e.g., an ultrasonic sensor) is grid-mapped on a grid map, direct wave information (i.e., (information characterized by ultrasonic waves forming a circular pattern due to identical Time of Flight (TOF) values for transmitted and received ultrasonic waves) and indirect wave information (i.e., information characterized by ultrasonic waves forming an elliptical pattern due to different Time of Flight (TOF) values for transmitted and received ultrasonic waves) are displayed together on the same grid map. In this case, the ultrasonic sensor has a constant field of view (FOV).

The sensor fusion method of the processor 130 will be described below.

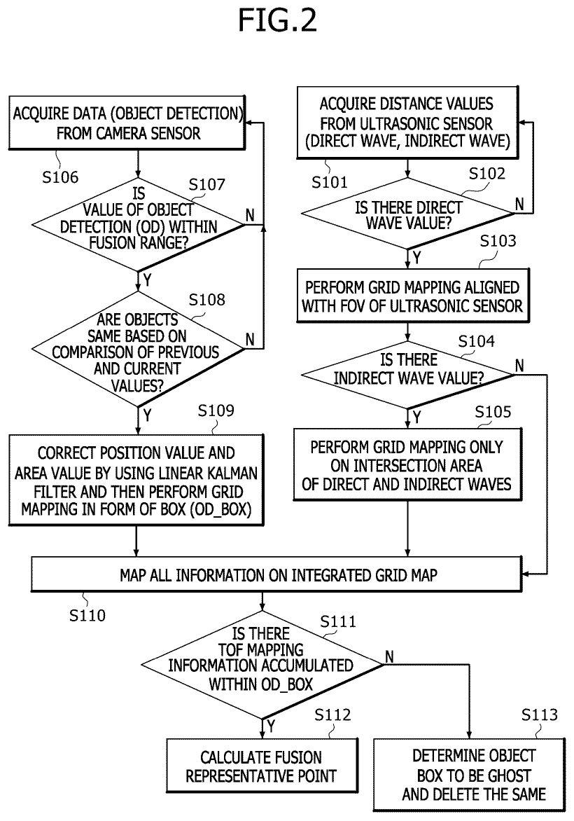

FIG. 2 is an exemplary view illustrating a sensor fusion method for a transportation apparatus according to an embodiment of the present disclosure.

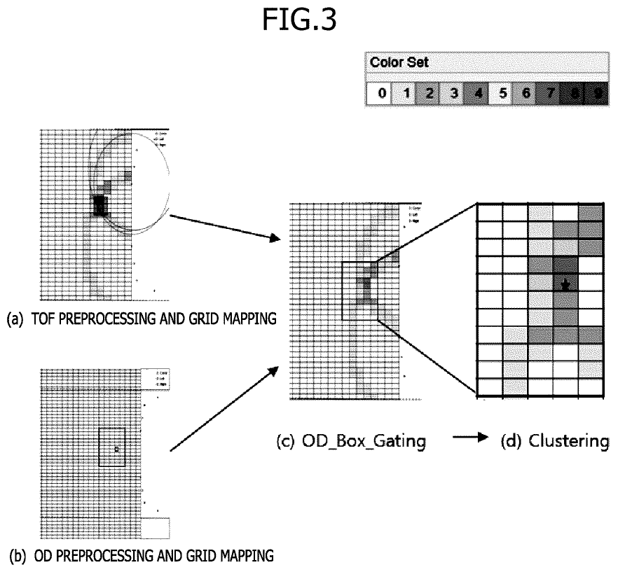

FIG. 3 is an exemplary view illustrating operations of preprocessing and grid mapping for an object detected through a first sensor and a second sensor in FIG. 2.

Referring to FIG. 2, the processor 130 acquires distance values (e.g., TOF of a direct wave and TOF of an indirect wave) from the first sensor (e.g., an ultrasonic sensor) through the first preprocessing module 110 (S101).

The processor 130 checks whether there is a direct wave value among the distance values acquired through the first sensor (e.g., an ultrasonic sensor) (S102).

If there is a direct wave value among the distance values acquired through the first sensor (e.g., an ultrasonic sensor) (Yes in S102), the processor 130 performs grid mapping aligned with an FOV of the first sensor (e.g., an ultrasonic sensor) (S103) (see (a) in FIG. 3).

The processor 130 checks whether there is an indirect wave value among the distance values acquired through the first sensor (e.g., an ultrasonic sensor) (S104).

If there is an indirect wave value among the distance values acquired through the first sensor (e.g., an ultrasonic sensor) (Yes in S104), the processor 130 performs grid mapping only on an intersection area of direct and indirect waves (S105) (see (a) in FIG. 3).

The processor 130 acquires object detection information (i.e., OD data) from image data detected through the second sensor (e.g., a camera sensor) by using the second preprocessing module 120 (S106).

The processor 130 checks whether a value of object detection information (i.e., OD data) detected through the second sensor (e.g., a camera sensor) is within a fusion range (S107). For example, the processor 130 checks whether there is an intersection of direct and indirect waves within an object box (OD_Box).

If the value of the object detection information (i.e., OD data) detected through the second sensor (e.g., a camera sensor) is within a specified fusion range (Yes in S107), the processor 130 checks whether objects are the same through comparison of previous and current values of the object detection information (i.e., OD data) (S108).

If the value of the object detection information (i.e., OD data) detected through the second sensor (e.g., a camera sensor) is within a specified fusion range, and if objects are determined to be the same through comparison of previous and current values of the object detection information (i.e., OD data) (e.g., Yes in S108), the processor 130 corrects a coordinate value and an area value based on a specified parameter by using a specified filter (e.g., a linear Kalman filter) and then performs grid mapping in the form of a box (i.e., OD_Box) (S109) (see (b) in FIG. 3).

The processor 130 integrates grid mapping information on an intersection area of direct and indirect waves among distance values acquired through the first sensor (e.g., an ultrasonic sensor) and grid mapping information in the form of a box (i.e., OD_Box, object box) on object detection information (i.e., OD data) detected through the second sensor (e.g., a camera sensor), and maps all the information on a single integrated grid map (S110) (see (c) of FIG. 3).

Based on all the information mapped on the integrated grid map, the processor 130 checks whether there is grid mapping information from the first sensor (i.e., grid mapping information on an intersection area of direct and indirect waves acquired through the first sensor (e.g., an ultrasonic sensor)) accumulated within a box (i.e., OD_Box, object box) for object detection information (i.e., OD data) (S111).

If there is grid mapping information from the first sensor (i.e., grid mapping information on an intersection area of direct and indirect waves acquired through the first sensor (e.g., an ultrasonic sensor)) accumulated within an object box (OD_Box)) (Yes in S111), the processor 130 clusters the largest values (e.g., a plurality of grids with the same largest value) among the grid mapping information from the first sensor accumulated to calculate a final coordinate (i.e., a final object coordinate or a fusion representative point)(S112).

If there is no grid mapping information from the first sensor (i.e., grid mapping information on an intersection area of direct and indirect waves acquired through the first sensor (e.g., an ultrasonic sensor)) accumulated within an object box (OD_Box)) (No in S111), the processor 130 determines the object box (OD_Box) to be a ghost and deletes the same (S113).

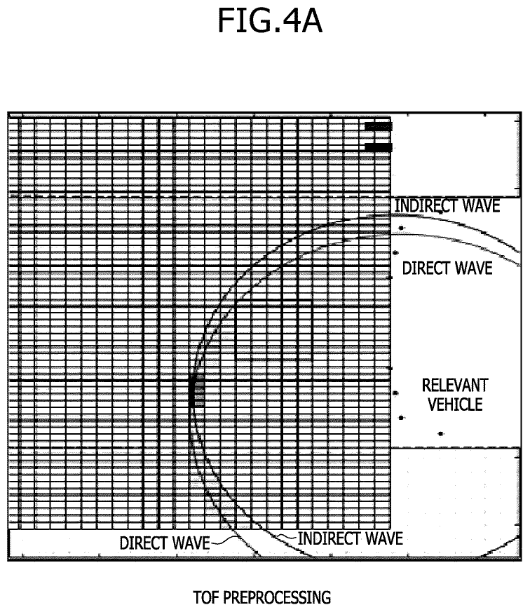

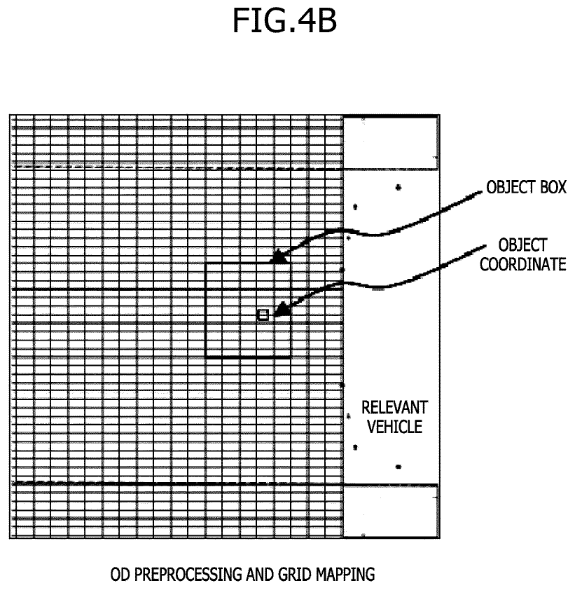

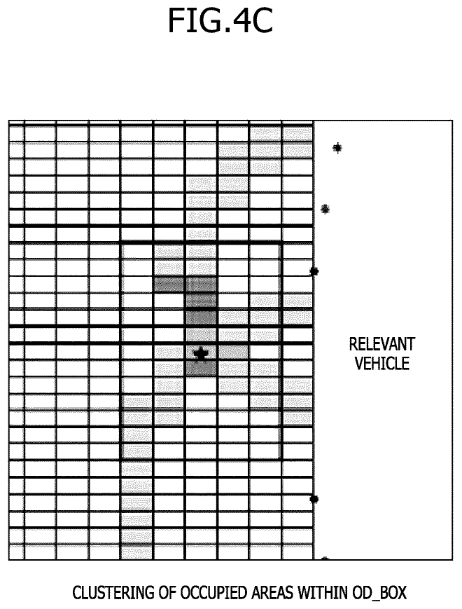

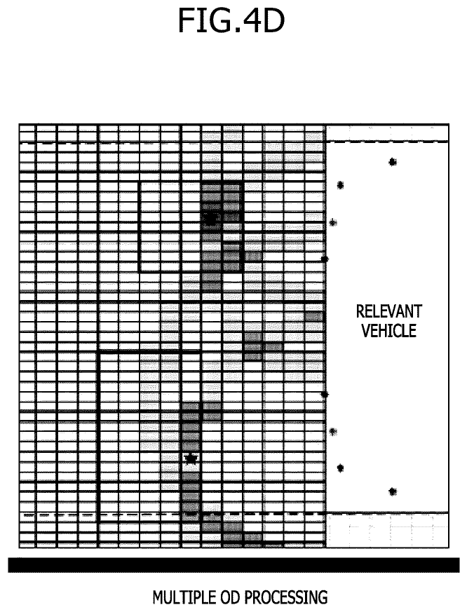

FIGS. 4A, 4B, 4C, and 4D illustrate operations of preprocessing and multi-grid mapping for an object detected through the first sensor and the second sensor in FIG. 2.

Referring to FIGS. 4A, 4B, 4C, and 4D, the processor 130 assigns a specified score only to an area (or grid), which is within the FOV, among direct waves of the first sensor (e.g., an ultrasonic sensor) through TOF preprocessing (a), and assigns a score only to an area (or grid) where an intersection with the direct wave is formed among the indirect wave information.

The processor 130 determines whether the objects are the same by comparing previous and current values of an object coordinate (OD coordinate) through OD preprocessing (b) (e.g., by comparing to determine whether a change in the object coordinate is within a specified range), corrects a coordinate value and an area value by using a specified filter (e.g., a linear Kalman filter), and then performs grid mapping in the form of a box (i.e., OD_Box). In this case, an index matching the corrected coordinate value is mapped on the grid map, and the index corresponding to the box (i.e., OD_Box, object box) is stored.

The processor 130 utilizes the index, which has been stored previously, corresponding to the object box (i.e., OD_Box) (start and end points of OD_Box) as a sensor fusion gate through clustering of occupied areas within the object box (i.e., OD_Box) (c).

For example, if there is no occupied area (i.e., grid mapping information on an intersection area of direct and indirect waves acquired through the first sensor (e.g., an ultrasonic sensor)) within the object box (i.e., OD_Box), the processor 130 determines the object box to be a ghost. If there is an occupied area (i.e., grid mapping information on an intersection area of direct and indirect waves acquired through the first sensor (e.g., an ultrasonic sensor)) within the object box (i.e., OD_Box) the processor 130 calculates (extracts) a final coordinate (i.e., a final object coordinate or a fusion representative point) through clustering.

The processor 130 may perform clustering processing for multiple objects through multiple OD processing (d).

For example, the processor 130 may set the number of clusters based on the number of object boxes (i.e., OD_Box). In this case, an initial centroid is the coordinate value of object detection information (i.e., OD data). The processor 130 then searches for the occupancy points (scores) within each object box (i.e., OD_Box), performs clustering with the average value of the largest values (scores, MaxPoint) within each object box (i.e., OD_Box), and calculates (extracts) a final coordinate (i.e., a final object coordinate or a fusion representative point) through clustering.

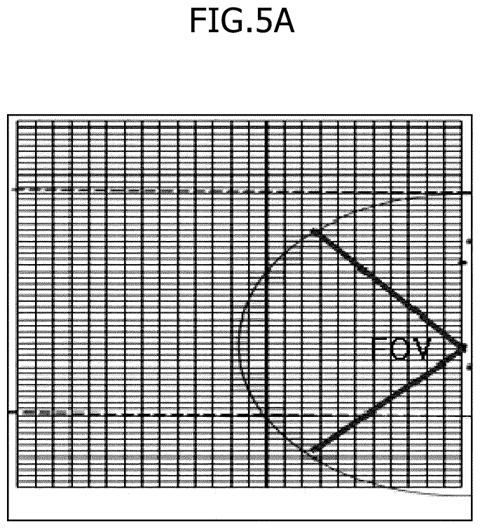

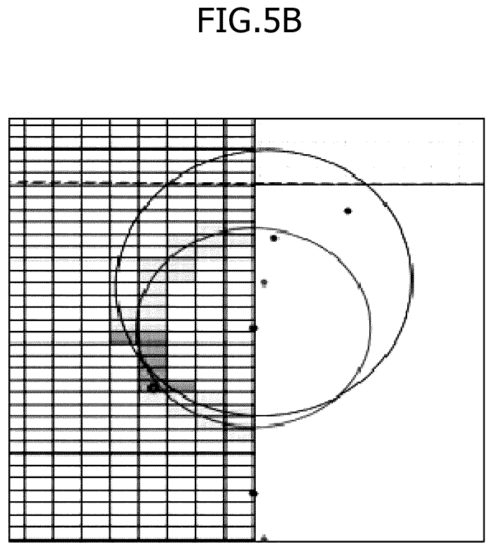

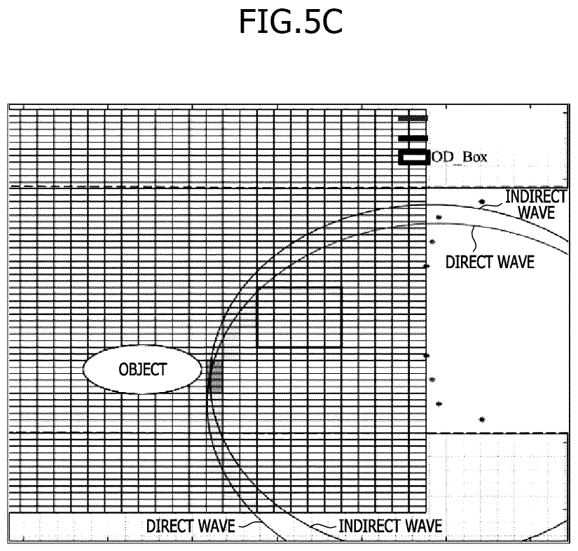

FIGS. 5A, 5B, and 5C illustrate grid mapping for direct and indirect waves detected through the first sensor (ultrasonic sensor) in FIG. 2.

Referring to FIGS. 5A, 5B, and 5C, for a direct wave (i.e., direct ultrasonic wave), the processor 130 performs grid mapping only on an area within the FOV of the first sensor (ultrasonic sensor). This is to prevent fusion of information outside the FOV with the OD (see FIG. 5A).

Referring to FIG. 5, for an indirect wave (i.e., indirect ultrasonic wave), the processor 130 performs grid mapping only on an area where there is an intersection with a direct wave. This is because the intersection of direct and indirect waves is a reflection point of a target (see FIG. 5B).

Referring to FIG. 5, the processor 130 performs grid mapping, based on a direct wave (i.e., only if a direct wave is detected), for the intersections with indirect waves through TOF preprocessing. This is to prevent incorrect fusion with another object not detected by direct waves.

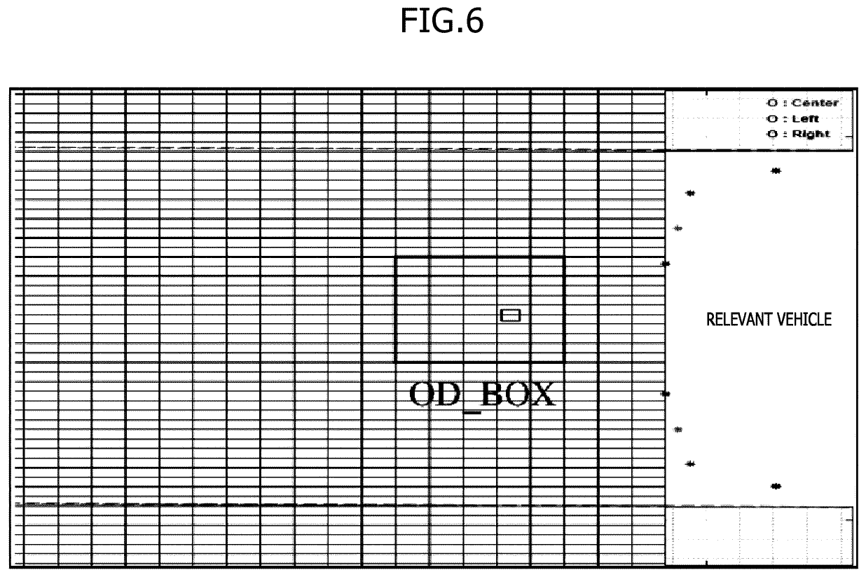

FIG. 6 is an exemplary view illustrating object detection (OD) preprocessing and grid mapping for an object detected through the second sensor (camera sensor) in FIG. 2.

The processor 130 selects objects, in order of proximity from a relevant vehicle, from object detection (OD) measurement values for each area (e.g., within the vehicle width and outside the vehicle width) based on a predetermined functional specification (e.g., image detection should detect up to 5 persons within the vehicle width and up to 3 persons each on the left and right outside the vehicle width, while sensor fusion should detect up to 3 persons in the vehicle width and up to 1 person each on the left and right outside the vehicle width).

When objects are selected, the processor 130 determines whether objects detected at specified time intervals corresponding to the movement of the vehicle are the same by comparing previous and current values of the selected objects. The comparison checks whether the values are within a specified range of position (coordinate) variation in order to determine whether the objects are the same.

For example, the processor 130 may determine that objects are the same when previous and current values of the selected objects are within a specified range of position (coordinate) variation, based on “(current position value−previous position value)≤speed (kph)×(0.02).” In image object detection with an update cycle of 66 ms, a distance that may be traveled in approximately 66 ms (distance=time×speed) may be calculated using (speed_kph)/(3.6)×0.066, which simplifies to speed_kph×(0.0183). However, considering measurement errors, the factor 0.0183 is set to 0.02. Thus, if a difference between the current position (coordinate) and the previous position (coordinate) exceeds speed (kph)×(0.02), the objects may be determined to be different from each other. In addition, the reason for dividing the speed by 3.6 is to convert k/h into m/s. However, it should be noted that the calculation method described above is illustrative and is not intended to be limiting.

As described above, the same object is continuously measured through the second sensor, and when the object is within a sensor fusion range, a coordinate value and a width (i.e., area value) are corrected by using a specified filter (e.g., a linear Kalman filter). Grid mapping is then performed in the form of an object box (i.e., OD_Box).

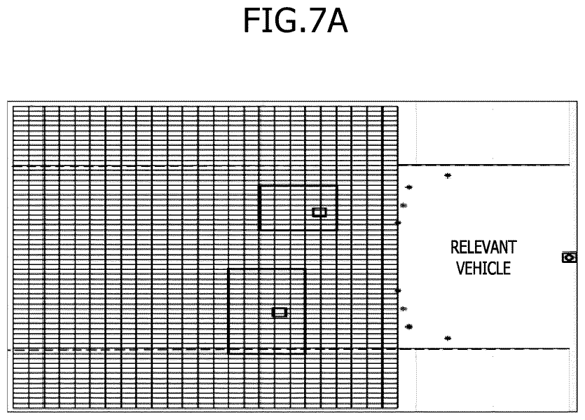

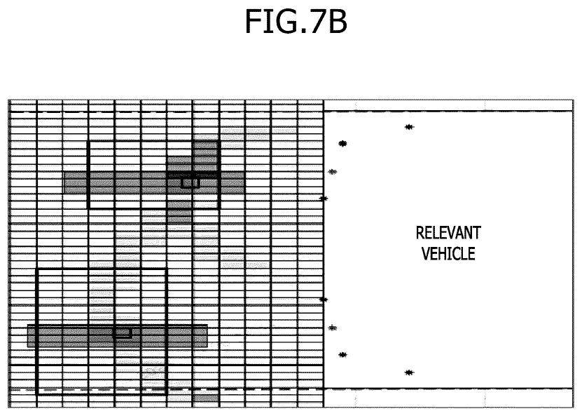

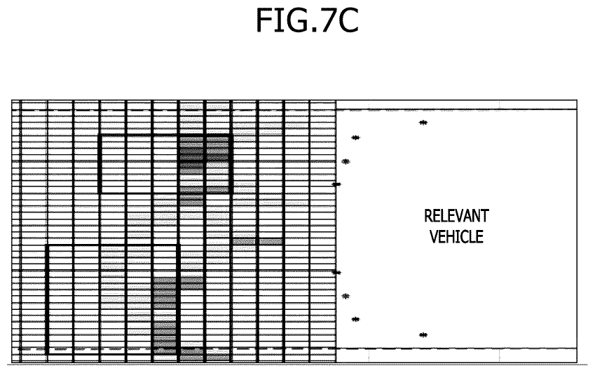

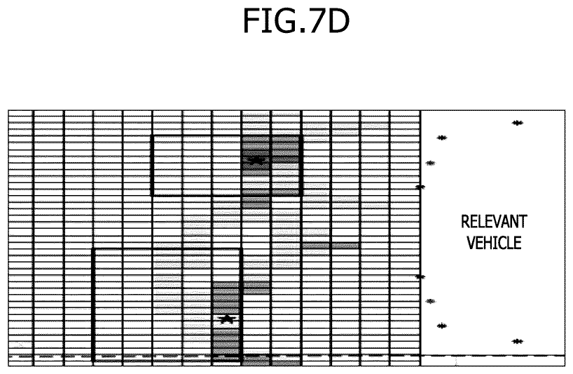

FIGS. 7A, 7B, 7C, and 7D illustrate a method for calculating a sensor fusion coordinate of an object on a grid map during the multi-grid mapping operation in FIG. 4.

Referring to FIG. 7A, the processor 130 may set the number of object boxes (i.e., OD_Box) using the number of clusters during the multi-grid mapping operation. For example, the number may be set to 3 within the vehicle width and 1 outside the vehicle width, and the setting may vary depending the predetermined functional specification.

Referring to FIG. 7B, an initial centroid may be set using a coordinate value (e.g., the Y coordinate value) from the object detection information (i.e., OD data). For example, in (b) in FIG. 7, the area-colored red indicates the initial centroid.

Referring to FIG. 7C, the processor 130 searches for the maximum occupancy point (score) and the number of occupancies within an object box (i.e., OD_Box). For example, in (c) in FIG. 7, the maximum occupancy point (score) is colored green, and the number of occupancies is 4.

Referring to FIG. 7D, the processor 130 performs clustering with the average value of the maximum occupancy points (scores) within each object box (i.e., OD_Box), and calculates (extracts) a final coordinate (i.e., a final object coordinate or a fusion representative point) through clustering.

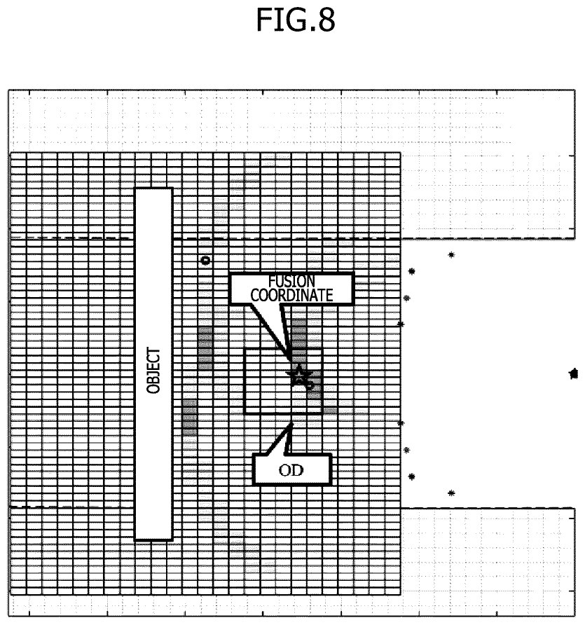

FIGS. 8, 9, 10A, 10B, 10C, and 10D illustrate an improved effect of sensor fusion according to an embodiment of the present disclosure compared to conventional sensor fusion.

Although a figure describing a conventional sensor fusion method is not illustrated, the conventional method has calculated an object coordinate by compensating for a TOF value while fixing the angle between an object coordinate value detected through a camera sensor and an ultrasonic sensor position, and has performed sensor fusion by using the Probabilistic Data Association Filter (PDAF). In this case, if noisy TOF caused by another object near the object falls within a gating range, sensor fusion has been performed, thereby decreasing coordinate accuracy.

However, as illustrated in FIG. 8, in the present embodiment, sensor fusion is performed by utilizing only an intersection area of the direct wave within the FOV of the ultrasonic sensor (i.e., through a combination of OD and TOF), thereby making sensor fusion robust against noise and thus improving identification accuracy.

In addition, the conventional method has used the Mahalanobis distance to perform sensor fusion using probabilistic association. This is a method of calculating the Mahalanobis distance to associate an estimated value with a measured value, and then determining objects to be the same if the calculated distance falls within a specified parameter and correcting a position by using the Kalman Gain. Thus, in order to process complex mathematical formulas (probabilistic formulas), load on a processor (e.g., an MCU) increases.

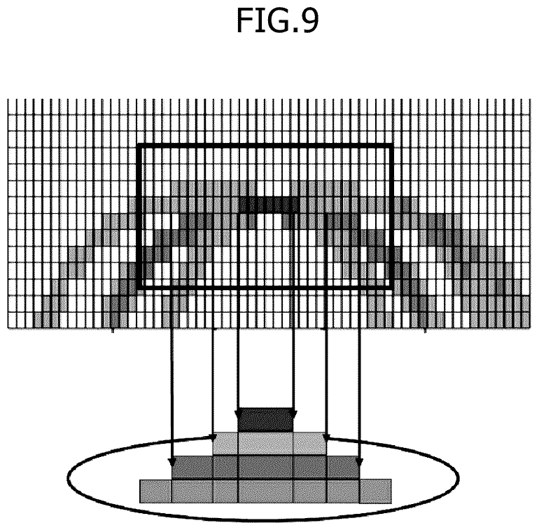

However, as illustrated in FIG. 9, the present embodiment reduces load on the processor (e.g., an MCU) by simply performing four arithmetic operations on grid scores (i.e., simplifying the mathematical model) instead of processing complex mathematical formulas (a probabilistic formula) after eliminating an area that is physically difficult to detect. However, it should be noted that the figure illustrated in FIG. 9 is illustrative to help understanding and is not intended to be limiting.

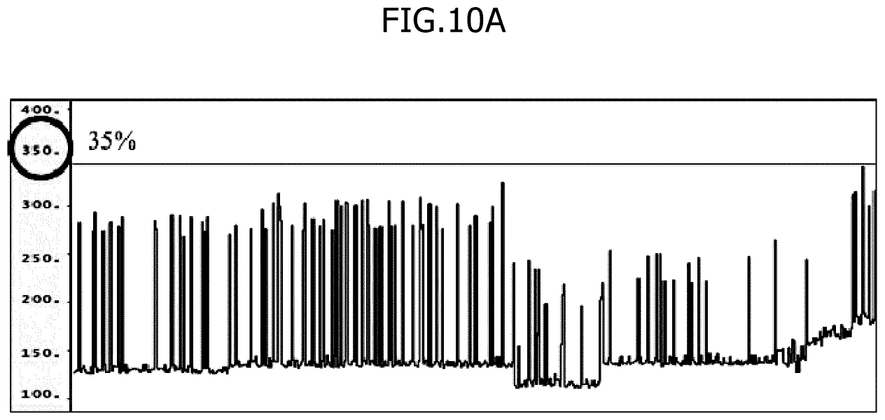

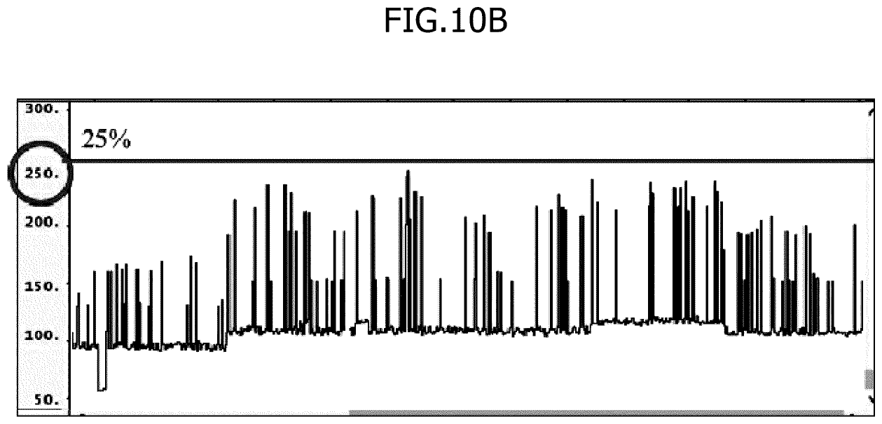

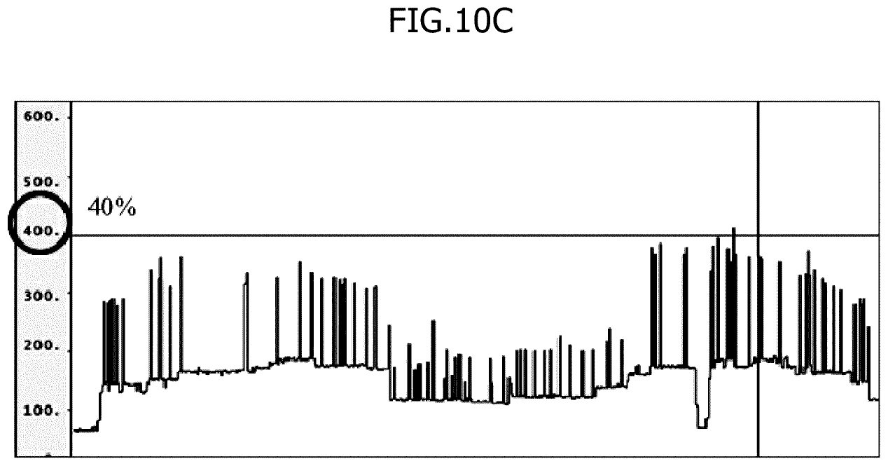

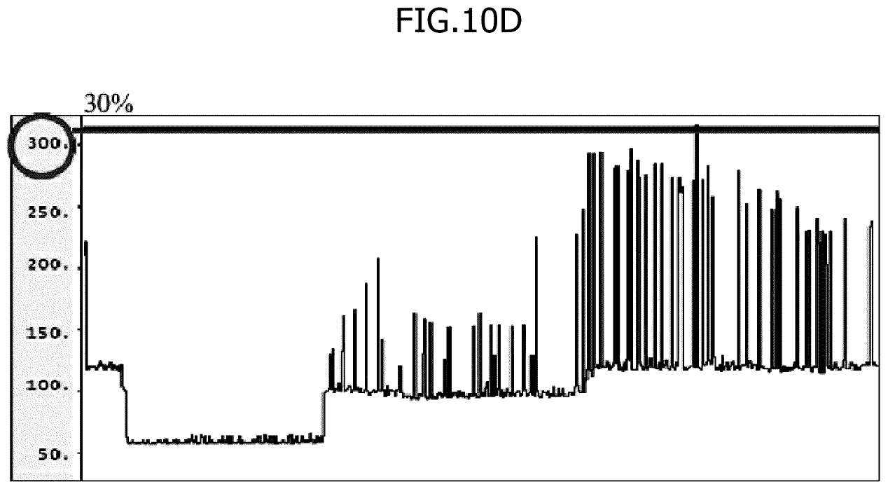

FIGS. 10A and 10B show measurements of the load on the processor (e.g., an MCU) when a child dummy is present in a parking space. FIG. 10A shows measurements of the load on a processor (e.g., an MCU) performing the conventional sensor fusion method, and shows that the load reaches up to 35% (i.e., when an object or a child dummy is present in a parking space, a large amount of sensor data is input such that a lot of computations are performed).

FIG. 10B shows measurements of the load on a processor (e.g., an MCU) performing the sensor fusion method according to the present embodiment, and shows that the load reaches up to 25%.

That is, when the sensor fusion method according to the present embodiment is performed, load on the processor (e.g., MCU) decreases by approximately 10 percentage points compared to the conventional method.

FIGS. 10C and 10D show measurements of the load on a processor (e.g., an MCU) when a child dummy is present in front of a wall. FIG. 10C shows measurements of the load on a processor (e.g., an MCU) performing the conventional sensor fusion method, and shows that the load reaches up to 40% (i.e., when an object or a child dummy is present in front of a wall, a large amount of sensor data is input such that a lot of computations are performed). FIG. 10D shows measurements of the load on a processor (e.g., an MCU) performing the sensor fusion method according to the present embodiment, and shows that the load reaches up to 30%.

That is, when the sensor fusion method according to the present embodiment is performed, load on the processor (e.g., MCU) is reduced by approximately 10 percentage points compared to the conventional method.

As described above, the present embodiment may improve identification accuracy through robustness against noise compared to the conventional method by utilizing the FOV of the ultrasonic sensor and an intersection area of the direct wave when fusing the ultrasonic sensor and the camera sensor mounted on the transportation apparatus by using a grid map.

In addition, the present embodiment may reduce computational load on the processor compared to the conventional method by performing sensor fusion through a simple mathematical model when fusing sensing data from the ultrasonic sensor mounted on the transportation apparatus and image data from the camera sensor mounted on the transportation apparatus by using a grid map.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A sensor fusion apparatus for a transportation apparatus, the sensor fusion apparatus comprising:
two or more sensors, each of the two or more sensors having different sensing characteristics, each of the two or more sensors sensing an object, respectively;
one or more processors configured to execute instructions; and
a memory storing the instructions, wherein execution of the instructions configures the one or more processors to:
perform first preprocessing and second preprocessing, the first preprocessing and second preprocessing comprising grid mapping for each object sensed by the two or more sensors, respectively; and
perform sensor fusion through clustering using an integrated grid map for each grid-mapped object.

2. The sensor fusion apparatus of claim 1, wherein the first preprocessing further comprises:
performing Time of Flight (TOF) preprocessing and the grid mapping for a first object detected through an ultrasonic sensor of the two or more sensors, and
wherein the second preprocessing further comprises:
performing object detection (OD) preprocessing and the grid mapping for a second object detected through a camera sensor of the two or more sensors.

3. The sensor fusion apparatus of claim 1, wherein the performing the sensor fusion further comprises:
clustering, through an intersection of an object calculated through the preprocessing and performing object box gating of an object calculated through the second preprocessing, by using the integrated grid map.

4. The sensor fusion apparatus of claim 1, wherein the performing the sensor fusion further comprises:
searching for occupancy scores of grids within an object box; and
performing clustering with an average value of grids having highest scores within the object box to calculate a final fusion representative point.

5. The sensor fusion apparatus of claim 4, wherein the performing the sensor fusion further comprises:
responsive to determining there is no grid mapping information from a first sensor of the one or more sensors accumulated within the object box, assessing the object box to be a ghost object box; and
deleting ghost object boxes.

6. The sensor fusion apparatus of claim 1, wherein the sensor fusion further comprises:
acquiring a first Time of Flight (TOF) value of a direct wave and a second TOF value of an indirect wave detected through a first sensor of the two or more sensors through the first preprocessing; and
responsive to a direct wave value being among the first TOF values, performing grid mapping aligned with a field of view (FOV) of the first sensor.

7. The sensor fusion apparatus of claim 6, wherein the sensor fusion further comprises:
responsive to a TOF value of an indirect wave being among the first TOF values, performing grid mapping only on an intersection area of direct and indirect waves.

8. The sensor fusion apparatus of claim 1, wherein the sensor fusion further comprises:
acquiring object detection information from image data detected through a second sensor of the two or more sensors through the second preprocessing; and
responsive to objects being confirmed to be the same through a comparison of previous and current values of the object detection information:
correcting a coordinate value and an area value based on a specified parameter by using a specified filter; and
performing grid mapping in a form of a box.

9. The sensor fusion apparatus of claim 1, wherein the sensor fusion further comprises:
integrating grid mapping information on an intersection area of direct and indirect waves among TOF values acquired through a first sensor of the two or more sensors;
grid mapping information in a form of an object box on object detection information detected through a second sensor of the two or more sensors; and
mapping all the information on a single integrated grid map.

10. A method, the method comprising:
performing, by a processor, preprocessing and grid mapping corresponding to a first sensor and a second sensor, respectively; and
performing, by the processor, sensor fusion through clustering using an integrated grid map for each preprocessed and grid-mapped object information.
